(19) United States
(12) Patent Application Publication
(10) Pub. No.: US 2011/0038564 A1
(43) Pub. Date: Feb. 17, 2011

(54) Reusable silicone bag

(76) Inventor: Cindy Ann Slansky, Huntington Station, NY (US)

Correspondence Address: CINDY SLANSKY, 6 CARLA COURT, HUNTINGTON STATION, NY, 11746, US

(21) Appl. No.: 12/583,083

(22) Filed: Aug. 14, 2009

(51) Int. Cl. B65D 33/16; B65D 30/16; B65D 33/04; B65D 30/20; B31B 1/90; B31B 1/00

(52) U.S. Cl. 383/64; 383/104; 383/106; 383/120; 493/214; 493/267

(57) ABSTRACT

A reusable bag, generally square, oblong or rectangular in shape, which is resealable by means of a top press and seal strip or strips, so that food stuffs or other items can be transported or stored in a sanitary condition. The bag may be composed entirely or in part of silicone so that it is durable, recyclable, impermeable to liquids and can withstand extremes of temperature making it suitable for freezing or thawing as well as transporting foods. The bag may be transparent, opaque or have various artistic designs or measurements incorporated into its manufacturing. The bag may also have a protrusion temporarily or permanently attached to it for attaching feeding utensils or various other items for transport along with the articles contained in the bag.

### FIELD OF THE INVENTION

The present invention relates generally to a reusable silicone rubber bag for storing, freezing and transporting food, drink or any other items which need to be kept sanitary or airtight.

### BACKGROUND OF THE INVENTION

Historically, plastic bags have been the primary means of transporting sandwiches and other food stuff and of storing frozen meats, vegetables or other foodstuffs. These prior art plastic bags are not suitable for heating or even thawing their contents in a microwave because of melting and leaching of their chemicals into the food they contain. These prior art plastic bags are also not strong enough to be used repeatedly or for heavier items. And, although these prior art plastic bags are usually waterproof; a major drawback is that they are not reusable, therefore not economical and not environmentally-friendly. Plastic bags are the cause of major environmental concerns. Plastic bags are made from non-renewable petroleum resources. Part of the problem of recycling plastic bags stems from the fact that bags may be made from one of several plastic types. For the most part, the recycling of plastic is limited in that it must be recycled into a product for non food use.

Another major drawback of prior art reusable plastic bags is that plastic production and processing require the use of toxic chemicals. Many manufacturing plants that produce these chemicals also produce hazardous waste and pollute the air. In 1986, the EPA, Environmental Protection Agency, ranked the 20 chemicals whose production generates the most hazardous waste. Five of the top six were chemicals commonly used by the plastic industry [propylene, phenol, ethylene, polystyrene, and benzene]. Therefore it is not only the final product that affects our environment but also the process by which these disposable bags are made.

Claims have been made that some plastic bags are degradable. In other words, they will decompose over time. Biodegradation takes place when air is present. Photodegradation occurs when sunlight is available. Approximately 95% of the garbage we generate is landfilled. In landfills, garbage is buried beneath layers of soil that make it difficult for air or sunlight to reach discarded items. The fact is that most plastic bags just don't degrade, even in a compost pile.

Plastic bags are high in fuel energy if they are burned, but they emit harmful gases that must be prevented from entering the atmosphere. Statistics show that we are consuming more and more plastics every year. It is estimated that an average individual uses around 130 plastic bags per year, most of which go straight to our landfills and which take an average of 1000 years to decompose. If each one of us could reuse a single bag instead of using dozens of plastic bags, we could make a major impact on the amount of plastic that enters our landfills.

Another means for transporting foodstuff has been hard plastic containers such as trademarked Tupperware™ containers. These containers can and have been manufactured with harmful chemicals such as BPA or phthalates which leach into the food they contain. BPA is the building block for plastics that are manufactured from polycarbonate. From such plastics, BPA leaches into food or beverages, and is believed to cause medical concerns. It is also advised not to heat any food in plastic containers because of this potential leaching of chemicals. It is the repeated heating, whether in the microwave or dishwasher, of these prior art plastic containers that contributes to the leaching of their chemicals, therefore the longer you use them, the more likely the chemicals will leach into the foods they contain. These plastic containers are also bulky and hard, making them difficult to carry and store. Another drawback of these plastic containers is that they are not sturdy enough to be reused indefinitely and that it is difficult to keep track of the lids. Yet another drawback is that they are not collapsible to adjust to their contents.

Some of the above mentioned drawbacks have been attempted to be solved by BPA-free aluminum food containers. These containers are also, however, very bulky and not easy to fold and store when not in use or for transport. Another drawback of these containers is that they are not collapsible to adjust to their contents. They are also not made for the freezing of meats or other foodstuff and they cannot be used in the microwave. Various plastic bags have been created such as that of patents U.S. Pat. Nos. 4,358,466, 5,261,532. These are still plastic bags, however, that cannot be reused indefinitely, therefore not economical and not environmentally friendly.

The prior art also does not addresses the consumer desire to have an aesthetically pleasing sandwich bag, especially for children of school age. The proposed invention may be manufactured with various designs for those that want something more fun than just an average plastic sandwich bag. The proposed invention also improves on existing disposable juice boxes in that it may have liquid measurements incorporated into its design making it easy to fill to whatever measurement the user may desire, instead of the typical 6-8 ounces that disposable juice boxes usually come in. The proposed invention would also save millions of disposable containers from entering our landfills. This would also save the consumer money because they could purchase bigger containers of drinks & refill a reusable silicone bag rather than purchasing drink boxes. This would also give the consumer the option of putting whatever drink they want in their childs lunch instead of limiting them to what is commercially available in disposable drink boxes. The above also applies to disposable infant bottle liners such as that of patent U.S. Pat. No. 7,467,893. Although these and similar prior art function as intended, they are all made of plastic and are all disposable. Again, the consumer would save money by not having to purchase disposable bottle liners over and over again, all the while saving millions of these plastic liners from entering our landfills.

None of the prior art containers address the specific need of being durable, reusable, recyclable, freezer and microwave oven safe, foldable for compact storage, and without the leaching of harmful chemicals. The prior art also does not address an aesthetic desire consumers may have, especially for kids, to carry a specially designed sandwich bag. The prior art also does not address the need for a reusable infant bottle liner. Accordingly, the need exists to overcome these problems of the prior art.

Accordingly, the present invention greatly improves on, if not revolutionizes, the shortcomings of prior art disposable plastic sandwich and freezer bags, disposable infant bottle liners and juice boxes as well as hard plastic containers and aluminum food containers as summarized below.

### SUMMARY OF THE INVENTION

According to the practice of this invention, a reusable and resealable bag may be comprised entirely or in part of silicone rubber which is generally, but not limited to, square, oblong or rectangular in shape. In a preferred embodiment, a front and a back portion that are identical to each other and that are permanently sealed together along both their sides as well as along their base, form a cavity therebetween to house various items for transport or storage. Said base may be gusseted to increase storage space and aid said bag in free-standing, making it easier to access its contents. Said embodiment is also comprised of an impermeably resealable horizontal top portion extending from said front and back portions respectively, further comprised of said front portion with one or more male tracks having a male profile and said back portion with one or more opposing female tracks having a female profile which are releasably engageable to each other by pressing and sliding them together either manually or by other means, forming an air and water tight seal.

Said silicone rubber is puncture-resistant, flexible for compact storage, non-stick, easy to clean and does not impart any flavor or odor to its contents.

In another embodiment, said reusable silicone bag may have a protrusion permanently or temporarily attached to it to hold various feeding utensils such as a straw, spoon or napkin. And with above said gusseted base, a consumer could easily stand the bag upright for ease of use with various attached feeding or drinking utensils.

In another embodiment, said reusable silicone bag may have fluid measurements incorporated into it's manufacture on one side, and have artistic designs and/or the above said protrusion incorporated into its manufacture on the other side. In this regard, it may be used as a bottle liner for an infant, and later used as a portable drink container for a toddler or child when done using it as a liner. This would continue the lifecycle of the product whereas most infant products and especially disposable bottle liners, are simply thrown away.

One objective of the present invention that greatly improves on existing disposable bags as well as other prior art food containers is that it can be indefinitely reused to freeze, thaw or heat food. It can also be indefinitely reused to transport or store various items in addition to food, such as pacifiers, toiletries, small toys or anything else which needs to be kept sanitary or air and water-tight.

Another objective of the present invention is to safely store and transport foodstuff without the danger of harmful chemicals being leached into its contents, accomplishing this by being manufactured entirely or in part of FDA-approved food-grade silicone, an inert material, which does not react with food or beverages, or produce any hazardous fumes.

Still another objective of the present invention is to withstand extremes of temperature ranging anywhere from below freezing up to 650 degrees Fahrenheit without degrading. Materials enclosed in said bag can go from the freezer to the microwave or dishwasher without affecting the quality of the product or the quality of its contents.

Still another objective of the present invention is to be easily and compactly folded for storage or transport.

Still another major objective of the present invention is to save millions of plastic bags and drink boxes from entering our landfills, further polluting our precious planet.

Still another objective of the present invention is to offer a fun and uniquely designed option for transporting snacks and sandwiches for children and adults alike while being economical and environmentally conscientious in reusing the same bag.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the enclosed abstract is to enable all those that read it, to determine quickly from a brief inspection the nature and essence of the technical disclosure of the application. The abstract is neither intended to define the invention of the application, which is measured by the claims, nor is it intended to be limiting as to the scope of the invention in any way.

### BRIEF DESCRIPTION OF DRAWINGS

FIG. 1 is a perspective view of a reusable bag type container according to a first embodiment of the present invention.

FIG. 2 is a perspective view of a reusable bag type container according to a second embodiment of the present invention where an artistic design is incorporated into its manufacturing.

FIG. 3 is a perspective view of a reusable bag type container according to a third embodiment of the present invention where a protrusion is incorporated into its manufacturing for attaching a straw, feeding utensil, or various other items for transport.

FIG. 4 is a perspective view of a reusable bag type container where the base of the container is gusseted.

FIG. 5 is a back view of a bag type container where the base is gusseted and there are fluid measurements incorporated into it's design.

FIG. 6 is the front view of the bag type container in FIG. 5 where there are artistic designs incorporated into its manufacture as well as a protrusion for holding various feeding utensils.

### DETAILED DESCRIPTION OF DRAWINGS

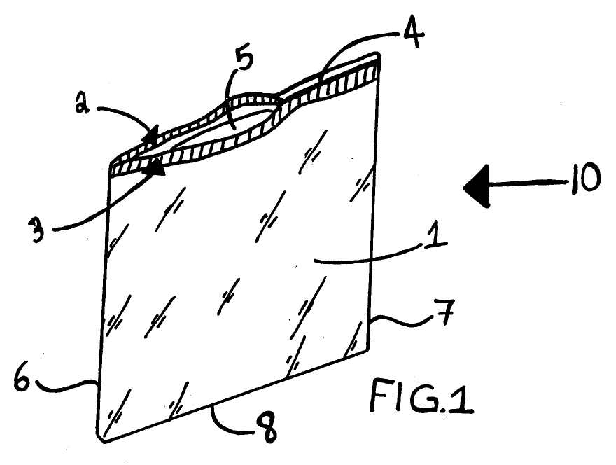

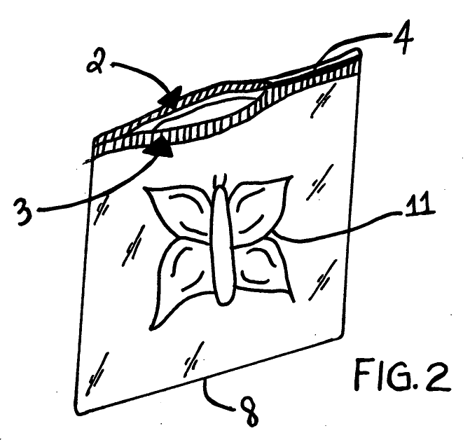

Referring to FIG. 1 and FIG. 2 of the accompanying drawings, a reusable bag 10, is comprised entirely or in part of silicone, making it able to withstand extremes of temperature ranging anywhere from −50 to 650 degrees Fahrenheit. The bag is further comprised of a front portion 1, and a back portion that are identical to each other and that are permanently sealed together along both their sides 6 and 7, as well as along their base 8, forming a cavity 5 therebetween. The bag is further comprised of an impermeably resealable horizontal top portion extending from said front 1 and back portions respectively, further comprised of said front portion 1 with one or more male tracks 3 having a male profile and said back portion with one or more opposing female tracks 2 having a female profile which are releasably engageable to each other by pressing, either manually or by other means, and sliding them together forming an air and water tight seal shown in closed or sealed position 4. Either the front 1 or back portions may have either the female tracks or the male tracks. The bag may be translucent, opaque colored or may have artistic designs 11 incorporated into its manufacturing.

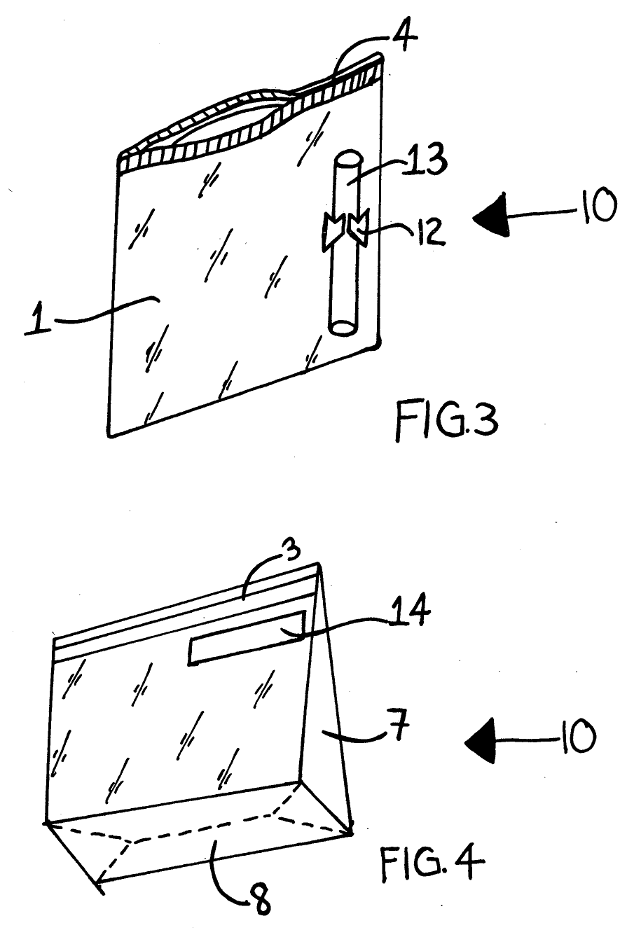

Referring to FIG.3 of the accompanying drawings, the reusable silicone bag 10 may also have a protrusion 12 permanently or temporarily attached to it for housing various items such as a straw 13, napkin, spoon etc. The protrusion 12 may take any shape that may house several different items.

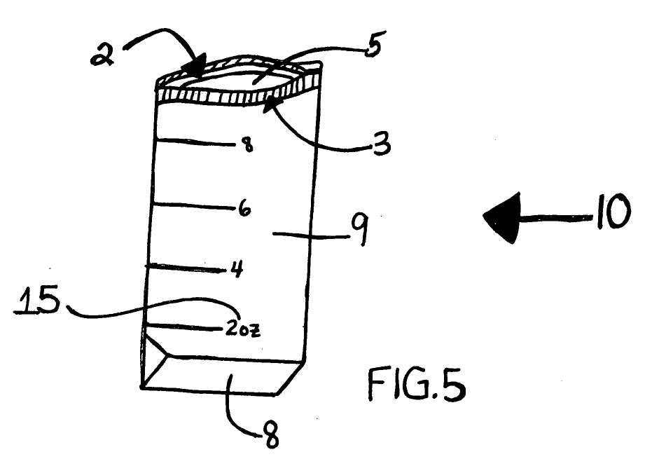

Referring to FIG. 4 of the accompanying drawings, the reusable silicone bag 10 may also have a base 8 that is gusseted to add to its storage space and aid the bag in free standing, making it easier to access its contents. It may also have a designated area 14 for writing of its contents so that when stored, the user may know at a glance what is inside the bag.

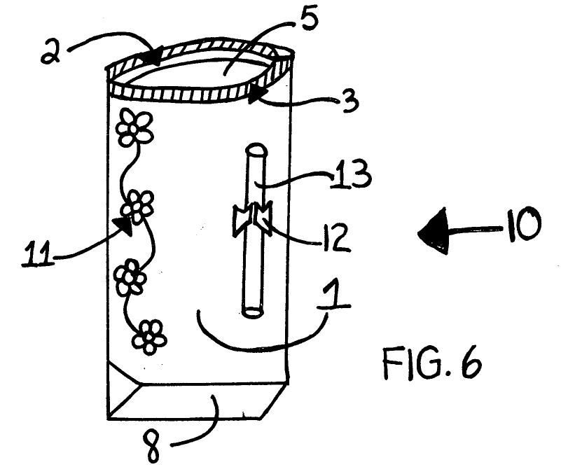

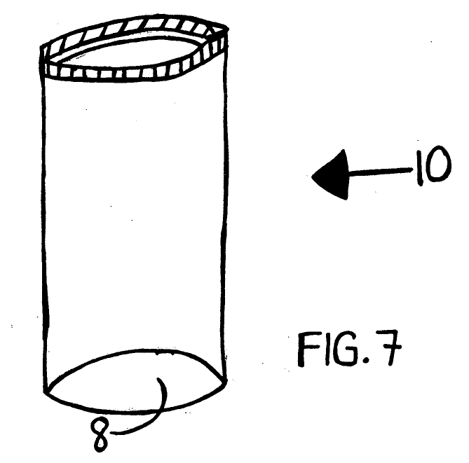

Referring to FIG. 5 and FIG. 6 of the accompanying drawings, the reusable silicone bag 10 may also be rectangular in shape and used as an infant bottle liner. In this manner, milk may be stored or transported in the reusable silicone bag. Liquid measurements 15 may also be incorporated into the bags design so that milk or other fluids may be measured. In this manner, the bag may also be used for a childs drink so that a parent may measure their childs fluid for transport in their lunch and attach a straw to the above mentioned protrusion 12. This way a parent can choose any drink they deem fit for their child and not just what is commercially available in disposable drink boxes. There may also be artistic designs 11 incorporated into the bags manufacture on one side and fluid measurements 15 on the other making it functional for an infant bottle liner and later aesthetically pleasing for a young child. Referring again to FIG. 5 and FIG. 6, the fluid measurements may be on the back portion 9 of the bag 10 and the artistic designs may be on the front portion 1. The base 8 may also be gusseted to make it easier for a child to stand their drink upright or for a parent to mix formula. Referring to FIG. 7, the base 8 of said reusable silicone bag 10 may also be rounded and gusseted making it better able to fit into an infant nurser bottle whereas the inherent concept of the present invention remains the same.

What is claimed is:

1) A reusable bag comprising:
a) a flexible rubber;
b) a generally, but not limited to, square, oblong or rectangular shape comprised of a front and a back portion that are identical to each other and that are permanently sealed together along both their sides as well as along their base, forming a cavity therebetween;
c) an impermeably resealable horizontal top portion extending from said front and back portions respectively, further comprised of said front portion with one or more male tracks having a male profile and said back portion with one or more opposing female tracks having a female profile which are releasably engageable to each other by pressing, either manually or by other means, and sliding them together forming an air and water tight seal.

2) A bag according to claim 1 wherein said flexible rubber is entirely or in part silicone.

3) A bag according to claim 1 wherein said base is gusseted whereby facilitating said bag in free-standing and adding additional space to bottom of said bag.

4) A bag according to claim 1 wherein said flexible rubber is translucent.

5) A bag according to claim 1 wherein said flexible rubber is opaque colored.

6) A bag according to claim 1 wherein said flexible rubber has artistic designs incorporated into its manufacturing.

7) A bag according to claim 1 wherein said flexible rubber can withstand extremes of temperature ranging anywhere from −50 up to 650 degrees Fahrenheit, without degrading or affecting its contents, whereby food may be frozen, thawed or repeatedly stored or transported.

8) A bag according to claim 1 wherein said flexible rubber has fluid measurements incorporated into its design whereby the user may measure liquids.

9) A bag according to claim 1 wherein a protrusion for releasably engaging various items is permanently or temporarily attached to said bag.

10) A bag according to claim 1 wherein said flexible rubber has a specific area designated for writing contents or other verbage.

11) A bag according to claim 1 wherein said rectangular shape may have a rounded gusseted base whereby the user may also reuse said bag as an infant bottle liner.

12) A bag according to claim 1 wherein either said front portion or said back portion may have said female track, or said front portion or said back portion may have said male track.

13) A method of forming a reusable bag comprising the step of: forming a reusable bag having a generally, but not limited to, square, oblong or rectangular shape comprised of a front and a back portion that are identical to each other and that are permanently sealed together along both their sides as well as along their base, forming a cavity therebetween;
further forming an impermeably resealable horizontal top portion extending from said front and back portions respectively, further comprised of said front portion with one or more male tracks having a male profile and said back portion with one or more opposing female tracks having a female profile which are releasably engageable to each other by pressing, either manually or by other means, and sliding them together forming an air and water tight seal; manufacturing said reusable bag entirely or in part of silicone rubber.
